(19) United States
(12) Patent Application Publication
(10) Pub. No.: US 2022/0019965 A1
(43) Pub. Date: Jan. 20, 2022

(54) COLD-CHAIN DELIVERY AND RETRIEVAL SYSTEM ON BASIS OF BLOCKCHAIN

(71) Applicant: Dong Ho Choi, Gangnam-gu, Seoul (KR)

(72) Inventor: Dong Ho Choi, Gangnam-gu, Seoul (KR)

(21) Appl. No.: 17/292,431

(22) PCT Filed: Nov. 6, 2019
(86) PCT No.: PCT/KR2019/014956

§ 371 Date: May 8, 2021

(30) Foreign Application Priority Data
Nov. 9, 2018 (KR) 10-2018-0137361

(51) Int. Cl. G06Q 10/08

(52) U.S. Cl. CPC G06Q 10/0832; G06Q 10/0833

(57) ABSTRACT

The present invention relates to a cold-chain delivery and retrieval system on the basis of a blockchain, comprising: a supplier terminal operated by a supplier who supplies items; a customer terminal used by a customer to order the items supplied by the supplier; a single server or a plurality of servers connected via a blockchain; an item storage device which stores the items prior to being received by the customer, and is provided with a plurality of unit storage boxes previously allocated to each of a plurality of suppliers, and a cooling unit configured to keep the unit storage boxes in a refrigerated or frozen state, wherein each of the plurality of unit storage boxes varies a loading space thereof according to the size of an item being stored therein; and a container return device to which a container used for packaging or storing the item is returned, wherein the container performs the function of managing the temperature of items.

### TECHNICAL FIELD

The present invention relates to a cold-chain delivery and retrieval system on the basis of a blockchain, more specifically to a cold-chain item delivery and container retrieval system based on a blockchain.

### BACKGROUND ART

In the process of delivery of an item ordered by a customer, the delivery is sometimes not made as intended including the item being lost and delivery to the wrong place. In particular, when an accident occurs in the process of delivering an item that is expensive or valuable, it is very important to analyze the cause and make a response.

Additionally, some of the containers used for packaging or storing items being delivered are reusable. Despite being reusable, the containers usually are not properly retrieved, and they end up as waste.

Meanwhile, cold-chain refers to a distribution method in which freshness is maintained by refrigeration and freezing. With cold-chain, temperature-sensitive items, such as fish, meat, fruits and vegetables, and pharmaceuticals, are delivered from production sites to consumers at low temperatures. For cold-chain, it is very important to maintain item quality in the delivery process, which is why special containers that perform the function of managing item quality (e.g., maintaining item temperature in a predetermined range) are used. Meanwhile, the special containers that manage item quality (e.g., maintaining item temperature in a predetermined range) are more costly than ordinary containers, which makes it very important to increase the rate of retrieval of the containers for cost reduction.

### DETAILED DESCRIPTION OF THE INVENTION

### Problem to be Solved

An object of the present invention is to provide a system that, in the event of an accident in the process of delivering an item (the item being lost, delivery in error, etc.), allows, by using blockchain technology, quick analysis of the cause and response by tracking its history.

Another object of the present invention is to increase the rate of retrieval of containers used for packaging or storing items (in particular, special containers used for cold-chain).

### Means for Solving the Problem

As a technical means to solve the above-mentioned problem, a delivery and retrieval system based on a blockchain according to an embodiment of the present invention comprises: a supplier terminal operated by a supplier who supplies items; a customer terminal used by a customer to order the items supplied by the supplier; a single server or a plurality of servers connected via a blockchain; an item storage device which stores the items prior to being received by the customer, and is provided with a plurality of unit storage boxes previously allocated to each of a plurality of suppliers, and a cooling unit for keeping the plurality of unit storage boxes in a refrigerated or frozen state, wherein each of the plurality of unit storage boxes varies a loading space thereof according to the size of an item being stored therein; and a container return device to which a container used for packaging or storing the item is returned, wherein the container performs the function of managing the temperature of items. The server is configured to, when a message indicating that an item sent by a supplier has arrived at the item storage device is received from the item storage device, record data relating to arrival information for the arrived item on a blockchain; when a message indicating that the item stored in the item storage device has been received by a customer or a deliverer is received from the item storage device, record data relating to receipt information for the received item on the blockchain; and when a message indicating that a container has been returned is received from the container return device, record data relating to return information for the returned container on the blockchain.

In an embodiment of the present invention, the data relating to arrival information may comprise information on the arrived item, information on the date and time of the arrival of the item, and information on the item storage device at which the item arrived, the data relating to receipt information may comprise information on the received item, information on the item storage device which stored the received item, information on the person who received the item, and information on the date and time of the receipt of the item, and the data relating to return information may comprise information on the returned container, information on the person who returned the container, information on the date and time of the return of the container, and information on the container return device to which the container was returned.

In an embodiment of the present invention, a delivery and retrieval system based on a blockchain may further comprise a container retrieval device which washes and manages the container retrieved from the container return device, and the server may be configured to, when a message indicating that the container has been retrieved is received from the container retrieval device, record data relating to retrieval information for the retrieved container on the blockchain and, when a message indicating that the container has been forwarded to the supplier or a third party is received from the container retrieval device, record data relating to forwarding information for the forwarded container on the blockchain.

In an embodiment of the present invention, the data relating to retrieval information may comprise information on the retrieved container, information on the date and time of the retrieval of the container, and information on the container retrieval device to which the container was retrieved, and the data relating to forwarding information may comprise information on the forwarded container, information on the entity to which the container was forwarded, and information on the date and time of the forwarding of the container.

In an embodiment of the present invention, the server may be configured to record, on the blockchain, data relating to distribution information for profits gained by retrieving the container.

In an embodiment of the present invention, the data relating to distribution information may comprise information on the entities to which the profits were distributed, information on the distribution amount and distribution ratio of the profits, and the date and time of the distribution of the profits.

### Effect of the Invention

With the delivery and retrieval system according to the present invention, when an accident occurs in the process of delivering an item (the item being lost, delivery in error, etc.), the cause can be analyzed and a response can be made quickly by tracking its history based on a blockchain.

Additionally, with the delivery and retrieval system according to the present invention, the rate of retrieval of containers used for packaging or storing items can be increased based on a blockchain. The rise in the rate of retrieval of containers can reduce the amount of waste generated due to containers, and contribute to economies and environmental protection for communities. In addition, by raising the rate of retrieval of containers, the costs regarding containers (in particular, special containers used for cold-chain) can be lessened.

The effects of the present invention are not limited to the above, and may be extended without departing from the scope of the idea and area of the present invention.

### BRIEF DESCRIPTION OF THE DRAWINGS

FIG. 1 is a block diagram showing the constitution of the delivery and retrieval system 100 according to an embodiment of the present invention.

FIG. 2 is a block diagram showing the constitution of a server 110 according to an embodiment of the present invention.

FIG. 3 is a drawing showing the constitution of an item storage device 140 according to an embodiment of the present invention.

FIG. 4 is a drawing showing the constitution of an item storage device 240 according to another embodiment of the present invention.

FIG. 5 is a drawing showing the constitution of a container return device 150 according to an embodiment of the present invention.

FIG. 6 is a drawing showing an integral item storage and container return device according to an embodiment of the present invention.

### DETAILED DESCRITPION TO CARRY OUT THE INVENTION

Hereinafter, embodiments of the present invention are described in detail with references to the drawings. The following embodiments of the present invention are only for specifying the present invention and do not limit or restrict the scope of the present invention. In addition, what can be easily inferred by those having ordinary skill in the technical field to which the present invention pertains from the detailed description and embodiments of the present invention is construed as belonging to the scope of the present invention.

The terms used in the present specification are briefly explained, before the present invention is described in detail.

Throughout the present specification, a portion ‘comprising’ a component may be construed to mean that it may comprise other components, not that other components are excluded, unless specified otherwise.

The term “unit” used in the specification means software or hardware such as FPGA and ASIC, and ‘units’ play certain roles. However, a ‘unit’ is not meant to be limited to software or hardware. A ‘unit’ may be configured to be in an addressable storage medium, or may be configured to activate one or more processors. Thus, as an example, a ‘unit’ includes components such as software components, object-oriented software components, class components, and task components, processes, functions, properties, procedures, subroutines, segments of program code, drivers, firmware, microcode, circuitry, data, a database, data structures, tables, arrays, and variables. Functions provided within components and ‘units’ may be combined into a smaller number of components and ‘units’ or may be further separated into additional components and ‘units.’

Additionally, throughout the specification, a singular expression may include its plural expression, unless the context clearly indicates otherwise.

Hereinafter, some embodiments of the present invention are described in detail with references to the attached drawings.

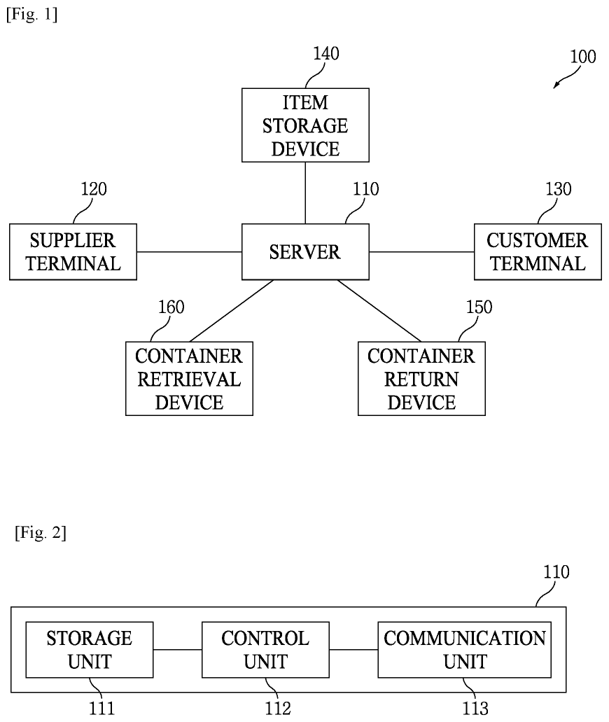

FIG. 1 is a block diagram showing a schematic constitution of the delivery and retrieval system 100 according to an embodiment of the present invention.

Referring to FIG. 1, the delivery and retrieval system 100 according to an embodiment of the present invention comprises: a single server 110 or a plurality of servers 110 connected via a blockchain; a supplier terminal 120 connected with the server 110 via a wired or wireless communication network and operated by a supplier who supplies items; a customer terminal 130 connected with the server 110 via a wired or wireless communication network and used by a customer to order the items supplied by the supplier; an item storage device 140 which is connected with the server 110 via a wired or wireless communication network and stores the items prior to being received by the customer; and a container return device 150 which is connected with the server 110 via a wired or wireless communication network and to which a container used for packaging or storing the item is returned. The delivery and retrieval system 100 according to an embodiment of the present invention may further comprise a container retrieval device 160 which is connected with the server 110 via a wired or wireless communication network, and washes and manages the container retrieved from the container return device 150. Although not illustrated in the drawings, the delivery and retrieval system 100 according to an embodiment of the present invention may further comprises a deliverer terminal connected with the server 110 via a wired or wireless communication network and used by a deliverer who delivers an item to a customer.

FIG. 1 is an example to describe an embodiment of the present invention, and a skilled person in the art could sufficiently understand that the delivery and retrieval system may comprises other components than those illustrated in FIG. 1 and that the components illustrated in FIG. 1 can be substituted with equivalent components .

The delivery and retrieval system 100 according to an embodiment of the present invention is characterized in that it is based on a blockchain. Blockchain refers to decentralized data storage technology where all users participating in the network distributes and stores data.

In a blockchain, a centralized server does not store and manage transaction records, but individual servers participating in transactions gather together to maintain and manage the network, and this individual server, i.e., a participant, is called a ‘node.’ In other words, in a blockchain, nodes on a decentralized network share a verified ledger with each other, and store and share data according to an agreement of the network.

Referring to FIG. 1, the delivery and retrieval system 100 according to an embodiment of the present invention comprises a single server 110 or a plurality of servers 110 connected via a blockchain. The server 110 may correspond to a node on the blockchain network. Although FIG. 1 illustrates only one server 110, a plurality of servers 110 connected via a blockchain may be used.

FIG. 2 is a block diagram showing a schematic constitution of a server (110) connected via a blockchain according to an embodiment of the present invention. Referring to FIG. 2, the server 110 may comprise a storage unit 111, a control unit 112 coupled to the storage unit, and a communication unit 113 communicating with an external device via a wired or wireless communication network.

The storage unit 111, as an embodiment, may comprise a supplier information database, an item information database, a customer information database, an item storage device information database, a delivery information database, a deliverer information database, a container return device information database, a container retrieval device information database, etc.

In the supplier information database and the item information database, data relating to information on item suppliers and items for sale may be stored respectively.

In the customer information database, data relating to information on customers (names, addresses, contacts, etc.) may be stored.

In the item storage device information database, data relating to information on the item storage device 140 (locations, types, etc.) may be stored, and data relating to a unit storage box 141 allocated to each supplier may be included in the data stored in the item storage device information database.

In the delivery information database, data relating to information on delivery of items may be stored, and data stored in the delivery information database may include information on whether the delivery of an item has started, the location of an item being delivered, whether an item has been received, and the like.

In the deliverer information database, data relating to information on deliverers of items (names, contacts, etc.) may be stored.

In the container return device information database and the container retrieval device information database, data relating to information on the container return device 150 and the container retrieval device 160 (locations, types, etc.) may be stored respectively.

The storage unit 111 may be constituted with various storage devices that can be accessed and processed by a computer, and data input and output at the storage unit 111 may be controlled by the control unit 112.

The control unit 112 executes a logistics management program as it exchanges data with the supplier information database, item information database, customer information database, item storage device information database, delivery information database, deliverer information database, container return device information database, container retrieval device information database, and the like included in the storage unit 111, and exchanges data with an external device via the communication unit 113. In terms of hardware, the control unit 112 may be constituted with a central processing unit where the logistics management program stored in memory.

The functions of the control unit 112 are described in further details as follows.

The control unit 112 stores data relating to supplier information and item information transmitted from the supplier terminal 120 via the communication unit 113 in the supplier information database and the item information database of the storage unit 111, and transmits the supplier information and the item information stored in the storage unit 111 to the customer terminal 130 via the communication unit 113 to provide information on the supplier and the item to the customer.

Additionally, the control unit 112 stores data relating to customer information in the customer information database of the storage unit 111, and transmits the customer information stored in the storage unit 111 to another device via the communication unit 113 to provide information on the customer.

Additionally, the control unit 112 transmits information on the item storage device 140 stored in the item storage device information database of the storage unit 111 to another device via the communication unit 113, and, in the event of a change to the item storage device information, stores it in the item storage device information database.

Additionally, the control unit 112 transmits delivery information stored in the delivery information database of the storage unit 111 to another device via the communication unit 113.

Additionally, the control unit 112 exchanges data with a deliverer via the communication unit 113 using deliverer information stored in the deliverer information database of the storage unit 111.

Additionally, the control unit 112 transmits information on the container return device 150 and the container retrieval device 160 stored in the container return device information database and the container retrieval device information database of the storage unit 111 to another device via the communication unit 113, and, in the event of a change to the container return device information and the container retrieval device information, stores it in the container return device information database and the container retrieval device information database.

Additionally, the control unit 112 may exchange other data necessary for item delivery and container retrieval with another external device via the communication unit 113.

The communication unit 113 is controlled by the control unit 112 to be used for communication with another external device.

Referring to FIG. 1 again, the delivery and retrieval system 100 according to an embodiment of the present invention comprises a supplier terminal 120, a customer terminal 130, and an item storage device 140.

The supplier terminal 120, which is a terminal operated by a supplier who supplies items, is connected with the server 110 via a wired or wireless communication network. The supplier terminal 120 may include all information and telecommunication devices capable of communicating with the server 110 such as desktop computers, laptop computers, tablet PCs, and smartphones. A supplier transmits information on an item for sale to the server 110 via the supplier terminal 120, and is provided with customer information, information on the item storage device 140, delivery information, etc. from the server 110 via the supplier terminal 120. Although FIG. 1 illustrates only one supplier terminal 120, a plurality of supplier terminals may be connected to the server 110 and used.

The customer terminal 130, which is a terminal used by a customer purchasing an item, is connected with the server 110 via a wired or wireless communication network. The customer terminal 130 may include all information and telecommunication devices capable of communicating with the server 110 such as desktop computers, laptop computers, tablet PCs, and smartphones. A customer accesses the server 110 via the customer terminal 130 to select an item and place an order, and is provided with delivery information, information for item receipt, etc. from the server 110 via the customer terminal 130. Although FIG. 1 illustrates only one customer terminal 130, a plurality of customer terminals may be connected to the server 110 and used.

The item storage device 140, which is a device storing the item ordered by the customer via the server 110, is preferably installed and located in a plurality of buildings where customers live or work including apartments, studio apartments used as offices, and schools. It may be otherwise located in main transportation areas such as subway stations. In addition, the storage device 140 is preferably installed in a building that receive items regularly delivered by a supplier to a customer. The present invention is not limited thereto, and an item that is not regularly delivered to a customer may also be stored in the storage device 140.

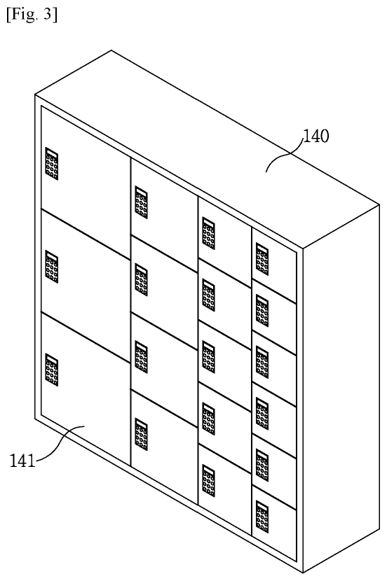

FIG. 3 shows a schematic constitution of an item storage device 140 according to an embodiment of the present invention.

Referring to FIG. 3, the storage device 140 may be provided with a plurality of unit storage boxes 141. The plurality of unit storage boxes 141 are categorized and arranged by size, and according to the present embodiment, unit storage boxes 141 in different rows have different sizes. In the present embodiment, a plurality of unit storage boxes 141 are previously allocated to each of a plurality of suppliers and then used according to contracts with the suppliers. The allocation of the unit storage boxes 141 to the suppliers may be stored in the container return device information database of the storage unit 111 of the server 110. The allocation of the unit storage boxes 141 to the suppliers may be modified. Items for a plurality of customers are respectively stored in the plurality of unit storage boxes 141 allocated to each of the suppliers. The item storage device 140 may be provided with doors that can be opened and closed, which are provided to the plurality of unit storage boxes 141 respectively, and passwords to open the doors are stored in the item storage device information database.

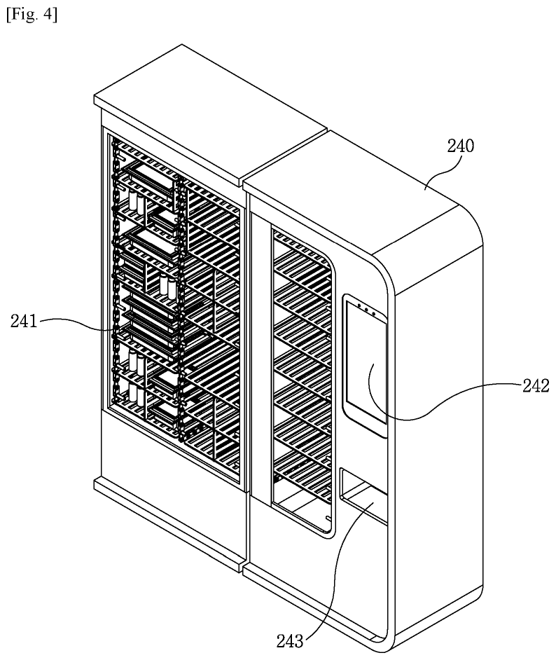

FIG. 4 shows a schematic constitution of an item storage device 240 according to another embodiment of the present invention.

Referring to FIG. 4, the item storage device 240 may be provided with a plurality of unit storage boxes 241, a display device 242 for opening and closing the unit storage boxes 241, and an item outlet 243. Each of the plurality of unit storage boxes 241 may be configured to vary a loading space thereof according to the size of an item being stored therein. The display device 242, which is provided for opening and closing the unit storage boxes 241, may be constituted with a user interface, a communication unit communicating with a user terminal, and a control unit. The item outlet 243 is provided for discharging an item stored in the unit storage boxes 241, and although FIG. 4 illustrates only one item outlet 243, a plurality of item outlets may be provided.

Although not illustrated in the drawings, the item storage device 140, 240 may be further provided with a communication unit for communication with the server 110. When an item is placed and stored in a unit storage box 141, 241 by a supplier or taken out of the unit storage box 141, 241 by a customer or a deliverer, the history is transmitted to the server 110 via the communication unit and stored in the delivery information database of the storage unit 111.

Although not illustrated in the drawings, the item storage device 140, 240 may be further provided with a cooling unit to allow storage of items that need to be kept in a refrigerated or frozen state. Although not illustrated in the drawings, the item storage device 140, 240 may be further provided with a temperature management device performing the function of managing the temperature of items.

Although not illustrated in the drawings, suppliers may be informed of item packaging means suitable for types and sizes of items and sizes and usages of the respective unit storage boxes 141, 241. The informing of the item packaging means may be performed by an output device such as the display device 242 provided to the item storage device, or performed by the server 110 providing relevant information via the supplier terminal 120. The item storage device 140, 240 may be used as a device in a main cold-chain delivery place for storage of items that need to be kept in a refrigerated or frozen state.

Referring to FIG. 1 again, the delivery and retrieval system 100 according to an embodiment of the present invention comprises a container return device 150.

The container return device 150, which is a device to which a container used for packaging or storing items is returned, is preferably installed and located in a plurality of buildings where customers live or work including apartments, studio apartments used as offices, and schools. It may be otherwise located in main transportation areas such as subway stations.

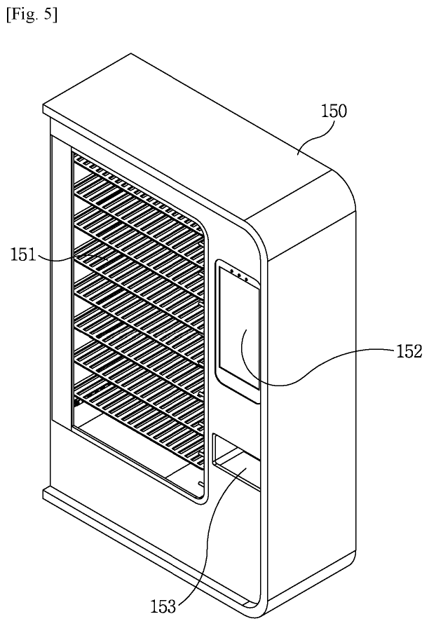

FIG. 5 shows a schematic constitution of the container return device 150 according to an embodiment of the present invention.

Referring to FIG. 5, the container return device 150 may be provided with a plurality of return boxes 151 where containers are returned and stored, a display device 152, and a container inlet 153. Each of the plurality of return boxes 151 may be configured to vary the size or width thereof according to the dimension of a container returned, or in a way such that only a container with a dimension corresponding to the size or width of the return box may be returned to the box.

In addition, each of the plurality of return boxes 151 may be configured to vary a loading space thereof according to the volume of a container being stored therein. The display device 152, which is used for returning a container, may be constituted with a user interface, a communication unit communicating with a user terminal, and a control unit.

When a container is returned to the container return device 150, the container return device 150 identifies the container based on, for example, information input via the display device 152, and transmits, to the server 110, a message indicating that the identified container has been returned. The container return device 150 may be configured to identify the container by recognizing a code displayed on the container (barcode, IC chip, magnetic, etc.).

The container return device 150 monitors the number of the containers returned to the container return device 150 in real time, and if the number of the returned containers is at a predetermined number or higher, transmits a retrieval request message to the server 110.

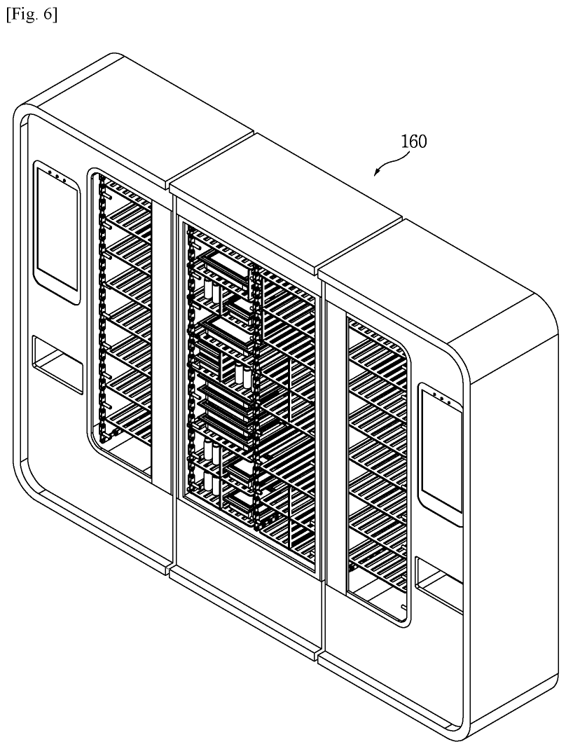

In the description above, the delivery and retrieval system 100 according to an embodiment of the present invention comprises the item storage device 140, 240 and the container return device 150 as separate devices, but the present invention is not limited thereto, and, as an embodiment, an item storage and container return device may be integrally implemented as illustrated in FIG. 6.

Referring to FIG. 1, the delivery and retrieval system 100 according to an embodiment of the present invention may further comprise a container retrieval device 160.

The container retrieval device 160 is a device that washes and manages the container retrieved from the container return device 150, and if the number of the containers returned to the container return device 150 is at a predetermined value or higher, the containers returned to the container return device 150 are retrieved to the container retrieval device 160. In the container retrieval device 160, the retrieved containers are washed and managed, and the washed and managed containers are forwarded to a supplier or a third party in need of the containers.

Although not illustrated in the drawings, the delivery and retrieval system 100 according to an embodiment of the present invention may further comprise a deliverer terminal.

The deliverer terminal, which is a terminal used by a deliverer who delivers an item to a customer, is connected with the server 110 via a wired or wireless communication network. As the deliverer terminal, an information and telecommunication device that can be easily carried such as a smartphone and a tablet PC may be used. A deliverer may be provided with location information for an item to be delivered from the server 110 via the deliverer terminal. In addition, the deliverer may access the server 110 via the deliverer terminal to register or modify deliverer information.

Hereinafter, a method for item delivery and container retrieval using the delivery and retrieval system 100 according to an embodiment of the present invention is described in detail with references to FIG. 1.

When a customer orders an item, delivery is carried out by a supplier of the item. The customer's order may be placed via the customer terminal 130.

When the item delivered by the supplier arrives at the item storage device 140, the item storage device 140 transmits a message indicating that the item has arrived to the server 110. When the message indicating that the item delivered by the supplier has arrived is received from the item storage device 140, the server 110 records data relating to arrival information for the item on a blockchain. The data relating to arrival information for the item may comprise information on the arrived item, information on the date and time of the arrival of the item, and information on the item storage device at which the item arrived.

When the message indicating that the item delivered by the supplier has arrived is received from the item storage device 140, the server 110 transmits a message indicating that the item ordered by the customer has arrived at the item storage device 140 to the customer terminal 130. Here, the customer may directly receive the item stored in the item storage device 140 or indirectly receive it through a deliverer.

More specifically, the method of a customer receiving an item may include direct receipt of the item by the customer from the item storage device 140 and indirect receipt where a deliverer takes the item from the item storage device 140 and forwards it to the customer. The customer may choose, via the customer terminal 130, either of the direct receipt and the indirect receipt, and the server 110 may identify the item receipt method chosen by the customer via the customer terminal 130.

In case of the direct receipt, the server 110 transmits a guide message on receiving to the customer terminal 130 of the customer who ordered the item stored in the item storage device 140. The guide message on receiving may include information on the item storage device 140 and the unit storage box 141 in which the item that the customer ordered is stored, verification data such as the password needed to open the opening/closing door of the unit storage box 141 or to have the item discharged, etc.

In case of the indirect receipt, the server 110 transmits a guide message on receiving to the deliverer terminal of the deliverer who delivers the item stored in the item storage device 140 to the customer who ordered it, and when the receipt of the item by the deliverer is confirmed, transmits a guide message on receiving to the customer. With that message, the customer is informed that the item stored in the item storage device 140 was received by the deliverer and is being delivered to the customer.

When the customer or the deliverer receives the item stored in the item storage device 140, the item storage device 140 transmits a message indicating that the item has been received to the server 110. When the message indicating that the item stored in the item storage device 140 has been received by the customer or the deliverer is received from the item storage device 140, the server 110 records data relating to receipt information for the item on the blockchain. The data relating to receipt information for the item may comprise information on the received item, information on the item storage device which stored the received item, information on the person who received the item, and information on the date and time of the receipt of the item.

In the delivery and retrieval system 100 based on a blockchain according to the present invention, information relating to delivery proceedings and storage of items ordered by customers in the process of delivering the items is recorded in detail on a blockchain in the manner described above. Accordingly, in the delivery and retrieval system 100 based on a blockchain according to the present invention, even if an item is lost or delivered to the wrong place due to an accident in the process of delivery, the cause can be analyzed and a response can be made quickly by tracking the history of the item recorded on the blockchain.

So far, the delivery and retrieval system 100 according to an embodiment of the present invention is described as being primarily used in cold-chain distribution where delivery is carried out while maintaining item freshness by refrigeration and freezing, but the invention is not limited thereto, and it can be used for distribution of all items that require temperature management including food such as home meal replacements (HMR), lunch box meals, and food made for delivery.

Meanwhile, for delivery of an item ordered by a customer, the item may be packaged or stored in a particular container. In addition, the container may be a special container that performs the function of managing the quality of the item (for example, maintaining item temperature in a predetermined range). In this case, the item packaged or stored in the container may be, for example, a pharmaceutical or food such as fish, meat, and fruits. In addition, it may be food such as home meal replacements (HMR), lunch box meals, and food made for delivery.

A customer who received the item that he or she ordered returns the container used to package or store the item to the container return device 150. When the container is returned to the container return device 150, the container return device 150 identifies the container by recognizing, for example, a code displayed on the container (barcode, IC chip, magnetic, etc.), and transmits, to the server 110, a message indicating that the identified container has been returned. When the message indicating that the container has been returned is received from the container return device 150, the server 110 records data relating to return information for the container on the blockchain. The data relating to return information for the container may comprise information on the returned container, information on the person who returned the container, information on the date and time of the return of the container, and information on the container return device to which the container was returned.

The delivery and retrieval system 100 according to an embodiment of the present invention may further comprises a container retrieval device 160 characterized in that it washes and manages the container retrieved from the container return device 150.

The container return device 150 monitors the number of the containers returned to the container return device 150 in real time, and if the number of the returned containers is at a predetermined number or higher, transmits a retrieval request message to the server 110. The containers returned to the container return device 150 are retrieved to the container retrieval device 160 by a container retrieval company or a container retriever, and the container retrieval device 160 washes and manages the retrieved containers.

When a container is retrieved to the container retrieval device 160, the container retrieval device 160 transmits, to the server 110, a message indicating that the container has been retrieved. When the message indicating that the container has been retrieved is received from the container retrieval device 160, the server 110 records data relating to retrieval information for the container on the blockchain. The data relating to retrieval information for the container may comprise information on the retrieved container, information on the date and time of the retrieval of the container, and information on the container retrieval device to which the container was retrieved.

A container washed and managed by the container retrieval device 160 may be forwarded back to the supplier or forwarded to a third party in need of the container. The container retrieval device 160 transmits a message indicating that the container has been forwarded to the supplier or third party to the server 110, and the server 110, which received the message, records data relating to forwarding information for the container on the blockchain. The data relating to forwarding information for the container may comprise information on the forwarded container, information on the entity to which the container was forwarded, and information on the date and time of the forwarding of the container.

In the delivery and retrieval system 100 based on a blockchain according to the present invention, a cycle of item delivery and container retrieval is carried in the manner described above, and information on item delivery and container retrieval is recorded in detail on a blockchain.

For the cycle to proceed smoothly, it is very important to increase the rate of retrieval of containers. In particular, if the containers are special containers that perform the function of managing item quality (e.g., maintaining item temperature in a predetermined range), increasing the rate of retrieval of the containers is even more important because they are more expensive than ordinary containers.

The delivery and retrieval system 100 according to the present invention is characterized in that the delivery process of a container can be tracked based on a blockchain. Recording all information on every step in the delivery process of a container on a blockchain allows raising the rate of retrieval of containers and significantly lowers the rate of loss of containers.

Meanwhile, in order to achieve a higher rate of retrieval of container, it is important to induce voluntary return of containers by customers. In order to induce voluntary return of containers by customers, in the delivery and retrieval system 100 according to the present invention, rewards may be provided in the form of online payment or points via the customer terminals 130 if customers return containers to the container return device 150. The entity that gives the rewards may be, for example, a supplier or an operator of the delivery and retrieval system 100 according to the present invention.

Additionally, when a container is retrieved properly, part of the profits gained by the retrieval of the container may be distributed to the entities in the delivery and retrieval system 100 according to the present invention (supplier, customer, deliverer, container retrieval company, etc.) This can help prevent the entities in the delivery and retrieval system 100 according to the present invention (supplier, customer, deliverer, container retrieval company, etc.) from leaving the system and maintain the delivery and retrieval system 100 according to the present invention in a sustained manner.

In the delivery and retrieval system 100 according to the present invention, containers are retrieved and reused, which can reduce the amount of waste generated due to containers, and contribute to economies and environmental protection for communities. When subsidies are provided from the government or a local government as rewards for contributing to economies and environmental protection for communities, part of the profits may be distributed to the entities in the delivery and retrieval system 100 according to the present invention (supplier, customer, deliverer, container retrieval company, etc.)

The server 110 records data relating to distribution information for profits gained by retrieving containers on the blockchain. The data relating to distribution information for profits may comprise information on the entities to which the profits were distributed, information on the distribution amount and distribution ratio of the profits, and the date and time of the distribution of the profits. The data relating to distribution information for profits may be shared among parties of interest only.

The delivery and retrieval system 100 according to an embodiment of the present invention is characterized in that it is based on a blockchain.

Blockchains can be broadly categorized into public blockchains, private blockchains, and consortium blockchains. First, in a public blockchain, anyone can participate in the network and access transaction history. Second, in a private blockchain, only the nodes approved by the network can participate according to predetermined rules, and it is not allowed to use the network or participate in an agreement process without approval. Lastly, in a consortium blockchain, various organizations or enterprises form a group to make up a blockchain network, and only the nodes of selected groups can participate in the network.

The delivery and retrieval system 100 according to the present invention is preferably designed as a private blockchain or a consortium blockchain so that data relating to item delivery and container retrieval and data relating to distribution of profits gained from retrieved containers are shared among parties of interest only.

In the delivery and retrieval system 100 according to the present invention, data recorded on a blockchain may be data agreed upon by a Smart Contract. A Smart Contract refers to a computer transaction protocol that executes terms and conditions of a contract. It is an ‘automated contract’ system that codes terms and conditions based on blockchain technology and automatically executes the contract when all programmed terms and conditions are satisfied. In the present invention, only the data agreed upon by such a Smart Contract may be allowed to be recorded on a blockchain.

The order of operations described in the methods or processes disclosed in the present specification are described as an example. Therefore, the order of the steps can be adjusted within the scope of the idea of the present invention as necessary. In addition, the devices and systems disclosed in the present specification may include means capable of performing the functions described in the present specification, and may be implemented as an independent device or system or may exist in a correlated or integrated form with another system as necessary.

The technology described in the present specification may be implemented at least in part with hardware, software, firmware, or any combination thereof. They may be implemented with, for example, at least one processor, DSP, ASIC, FPGA, or equivalent logic circuitry, or any combination of at least one of them. Such hardware, software, and firmware may be implemented in one or more systems or devices to support the operations and functions disclosed in the present specification, or may be implemented in a form correlated or integrated with another system or device. In addition, the components described in the present specification may be implemented separately or together with separate but interoperable logic devices. Each function and operation is described separately from each other in the present specification just to emphasize each function. Such functions are not necessarily implemented in separate hardware, firmware, or software components, and may be incorporated into the same or different combination of hardware and/or software.

Additionally, the technology described in the present specification may also be implemented or stored in a computer-readable storage medium comprising instructions. In addition, the instructions stored in the computer-readable storage medium may cause a method and an operation related to the instructions to be performed by a processor. Computer-readable storage medium may include RAM, ROM, PROM, EPROM, EEPROM, flash memory, hard disk, CD-ROM, magnetic medium, optical medium, or other storage media.

In the above, the present invention is described with references to preferred embodiments, but those skilled in the art would understand that the present invention can be modified and changed in a variety of manners without departing from the idea and scope of the present invention described in the following claims.

Specific structural or functional descriptions of the embodiments of the present invention disclosed herein are only for the purpose of description of the embodiments of the present invention, and embodiments of the present invention may be implemented in various forms and should not be construed as being limited to the embodiments described herein, and should be understood to include all modifications, equivalents, and substitutes included in the idea and technological scope of the present invention.

What is claimed:

1. A delivery and retrieval system based on a blockchain, characterized in that a cycle of item delivery and container retrieval is carried out based on a blockchain, the system comprising:
a supplier terminal operated by a supplier who supplies items;
a customer terminal used by a customer to order the items supplied by the supplier;
a single server or a plurality of servers connected via a blockchain;
an item storage device which stores the items prior to being received by the customer, and is provided with a plurality of unit storage boxes previously allocated to each of a plurality of suppliers, and a cooling unit for keeping the plurality of unit storage boxes in a refrigerated or frozen state, wherein each of the plurality of unit storage boxes varies a loading space thereof according to the size of an item being stored therein;
a container return device to which a container used for packaging or storing the item is returned, wherein the container performs the function of managing the temperature of items; and
a container retrieval device which washes and manages the container retrieved from the container return device,
wherein the server is configured to,
when a message indicating that an item sent by a supplier has arrived at the item storage device is received from the item storage device, record data relating to arrival information for the arrived item on a blockchain;
when a message indicating that the item stored in the item storage device has been received by a customer or a deliverer is received from the item storage device, record data relating to receipt information for the received item on the blockchain;
when a message indicating that a container has been returned is received from the container return device, record data relating to return information for the returned container on the blockchain;
when a message indicating that the container has been retrieved is received from the container retrieval device, record data relating to retrieval information for the retrieved container on the blockchain; and
when a message indicating that the container has been forwarded to the supplier or a third party is received from the container retrieval device, record data relating to forwarding information for the forwarded container on the blockchain.

2. The delivery and retrieval system based on a blockchain according to claim 1,
wherein the data relating to arrival information comprise information on the arrived item, information on the date and time of the arrival of the item, and information on the item storage device at which the item arrived,
the data relating to receipt information comprise information on the received item, information on the item storage device which stored the received item, information on the person who received the item, and information on the date and time of the receipt of the item,
the data relating to return information comprise information on the returned container, information on the person who returned the container, information on the date and time of the return of the container, and information on the container return device to which the container was returned,
the data relating to retrieval information comprise information on the retrieved container, information on the date and time of the retrieval of the container, and information on the container retrieval device to which the container was retrieved, and
the data relating to forwarding information comprise information on the forwarded container, information on the entity to which the container was forwarded, and information on the date and time of the forwarding of the container.

3. The delivery and retrieval system based on a blockchain according to claim 1,
wherein the server is configured to record, on the blockchain, data relating to distribution information for profits gained by retrieving the container.

4. The delivery and retrieval system based on a blockchain according to claim 3,
wherein the data relating to distribution information comprise information on the entities to which the profits were distributed, information on the distribution amount and distribution ratio of the profits, and the date and time of the distribution of the profits.

5. The delivery and retrieval system based on a blockchain according to claim 1,
wherein the item storage device and the container return device are implemented in an integral form.
